(19) United States
(12) Patent Application Publication
(10) Pub. No.: US 2018/0326259 A1
(43) Pub. Date: Nov. 15, 2018

(54) BASKETBALL TRACKING SYSTEM

(71) Applicant: Flores Hilman, Rancho Cucamonga, CA (US)

(72) Inventor: Flores Hilman, Rancho Cucamonga, CA (US)

(21) Appl. No.: 15/590,065

(22) Filed: May 9, 2017

(51) Int. Cl. A63B 24/00; A63B 69/00; A63B 43/00; G01S 19/51; G01S 5/00; G01S 5/02

(52) U.S. Cl. CPC A63B 24/0021; A63B 69/0071; A63B 43/00; G01S 19/51; G01S 5/0054; A63B 41/00; G01S 5/0284; G01S 5/0289; A63B 2024/0028; A63B 2024/0056; G01S 5/02

(57) ABSTRACT

A basketball tracking system includes a basketball that is manipulated during game play with respect to the game of basketball. A first remote tracking unit is coupled to the basketball to detect when the basketball is touched. A second remote tracking unit is worn during game play. A basketball court is provided and the basketball court has a perimeter and a pair of basketball goals. A base tracking array is positioned around the basketball court and on each of the basketball goals. Each of the first and second remote tracking units is in electrical communication with the base tracking array. The base tracking array tracks a location of the basketball on the basketball court during game play. The base tracking array storing data received from the basketball during game play to facilitate the date to be subsequently analyzed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to tracking devices and more particularly pertains to a new tracking device for tracking a player and a basketball in real time during game play.

### BRIEF SUMMARY OF THE INVENTION

An embodiment of the disclosure meets the needs presented above by generally comprising a basketball that is manipulated during game play with respect to the game of basketball. A first remote tracking unit is coupled to the basketball to detect when the basketball is touched. A second remote tracking unit is worn during game play. A basketball court is provided and the basketball court has a perimeter and a pair of basketball goals. A base tracking array is positioned around the basketball court and on each of the basketball goals. Each of the first and second remote tracking units is in electrical communication with the base tracking array. The base tracking array tracks a location of the basketball on the basketball court during game play. The base tracking array storing data received from the basketball during game play to facilitate the date to be subsequently analyzed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a basketball and a cradle of a basketball tracking system according to an embodiment of the disclosure.

FIG. 2 is a cutaway perspective view of basketball of an embodiment of the disclosure.

FIG. 3 is a phantom view of a second tracking unit of an embodiment of the disclosure.

FIG. 4 is a perspective in-use view of an embodiment of the disclosure.

FIG. 5 is a perspective view of an alternative embodiment of the disclosure.

FIG. 6 is a schematic view of an embodiment of the disclosure.

### DETAILED DESCRIPTION OF THE INVENTION

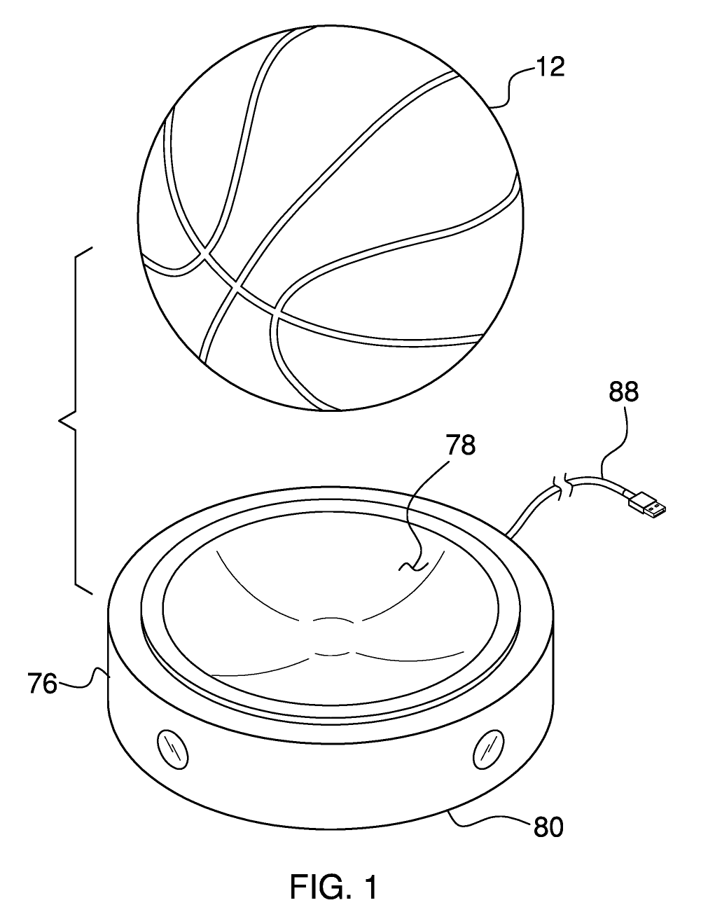

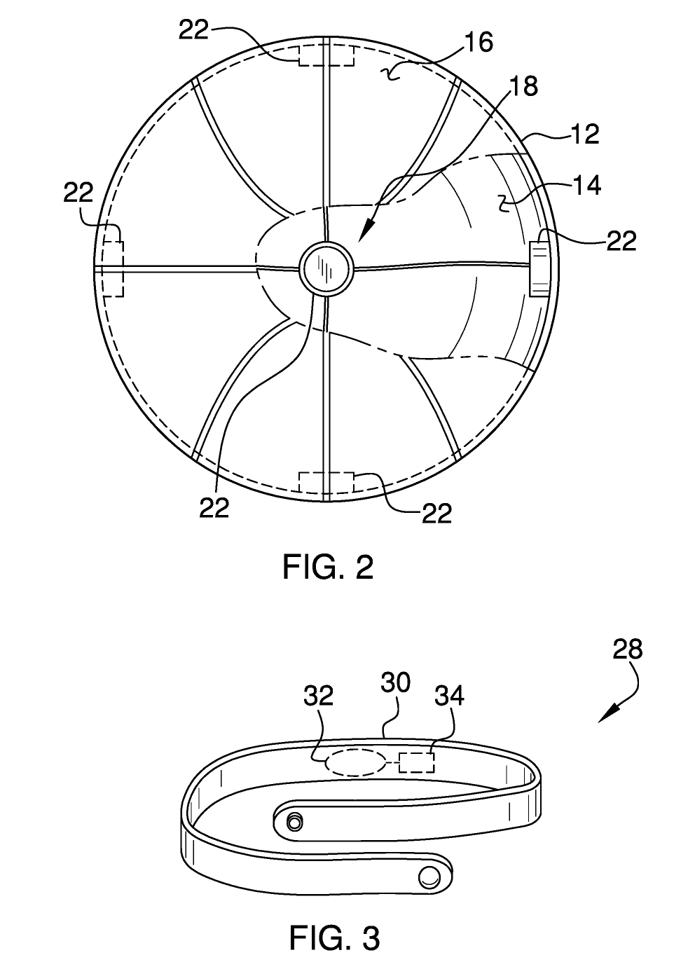

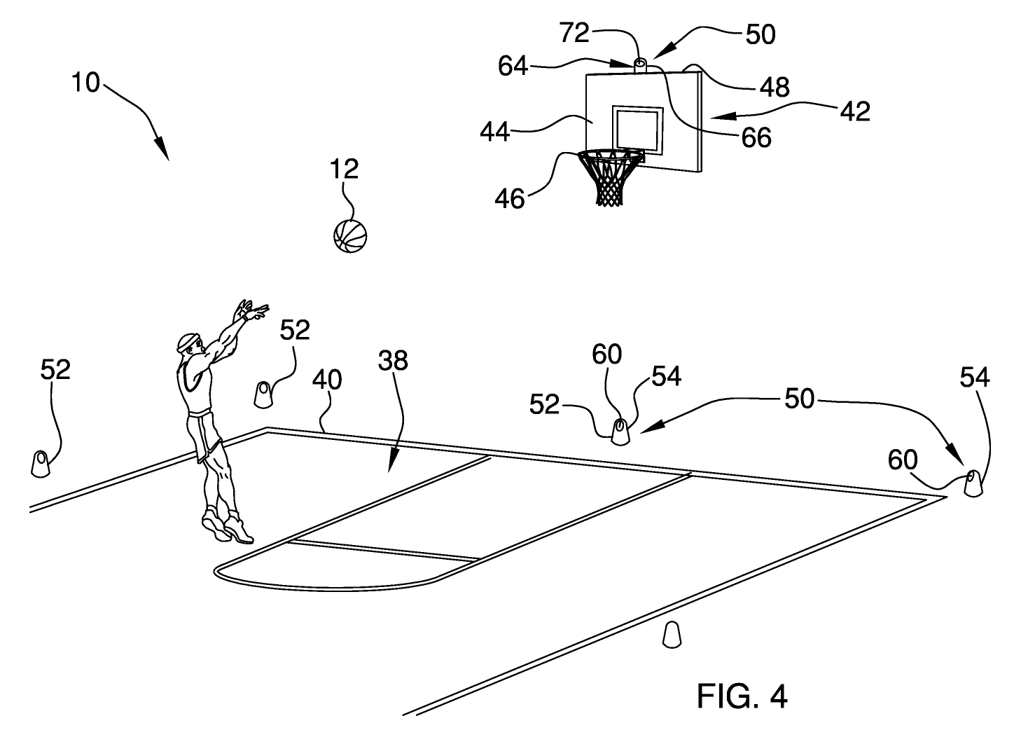

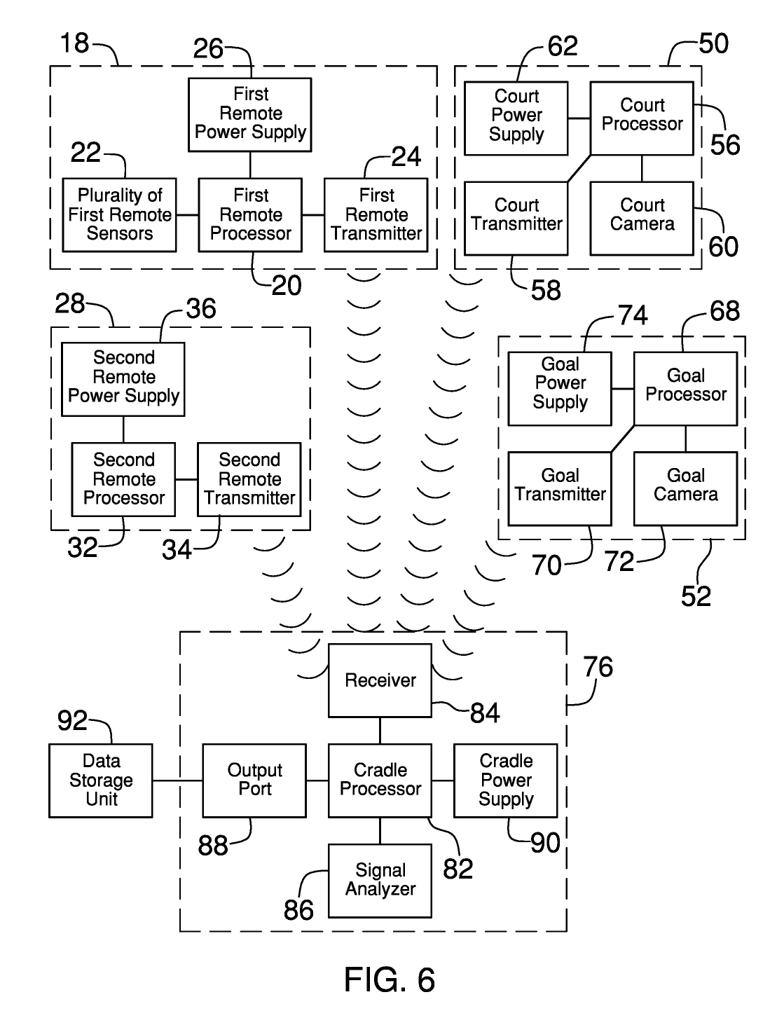

With reference now to the drawings, and in particular to FIGS. 1 through 6 thereof, a new tracking device embodying the principles and concepts of an embodiment of the disclosure and generally designated by the reference numeral 10 will be described.

As best illustrated in FIGS. 1 through 6, the basketball tracking system 10 generally comprises a basketball 12. The basketball 12 is selectively manipulated during game play with respect to the game of basketball 12. The basket ball has an inner surface 14 and an outer surface 16. Moreover, the basketball 12 may be a basketball 12 of any conventional size and design.

A first remote tracking unit 18 is coupled to the basketball 12. The first remote tracking unit 18 detects when the basketball 12 is touched. The first remote tracking unit 18 emits a first tracking signal when the basketball 12 is manipulated during game play. The first remote tracking unit 18 comprises a first remote processor 20 that is coupled to the inner surface 14 of the basketball 12 and the first remote processor 20 selectively generates a link sequence.

A plurality of first remote sensors 22 is provided and each of the first remote sensors 22 is coupled to the inner surface 14 of the basketball 12. Each of the first remote sensors 22 is electrically coupled to the first remote processor 20. The first remote sensors 22 are spaced apart from each other and are distributed around the basketball 12. Each of the first remote sensors 22 extends through the outer surface 16 to detect when the basketball 12 is touched. The first remote processor 20 generates the link sequence when the plurality of first remote sensors 22 detects that the basketball 12 has been touched. Each of the first remote sensors 22 may be an electronic touch sensor or the like.

A first remote transmitter 24 is coupled to the inner surface 14 and the first remote transmitter 24 is electrically coupled to the first remote processor 20. The first remote transmitter 24 emits the first tracking signal when the first remote processor 20 generates the link sequence. The first remote transmitter 24 may be a radio frequency transmitter or the like. Additionally, the first remote transmitter 24 may employ a WPAN signal and Bluetooth communication protocols. A first remote power supply 26 is coupled to the inner surface 14 and the first remote power supply 26 is electrically coupled to the first remote processor 20. The first remote power supply 26 comprises at least one battery.

A second remote tracking unit 28 is provided and the second remote tracking unit 28 is worn during game play. The second remote tracking unit 28 emits a second tracking signal. The second remote tracking unit 28 comprises a wrist band 30 that is worn on a player during game play. A second remote processor 32 is coupled to the wrist band 30 and the second remote processor 32 may be an electronic processor or the like.

A second remote transmitter 34 is coupled to the wrist band 30 and the second remote transmitter 34 is electrically coupled to the second remote processor 32. The second remote transmitter 34 emits the second tracking signal. The second remote transmitter 34 may be a radio frequency transmitter or the like. Moreover, the second remote transmitter may employ a WPAN signal and Bluetooth communication protocols. A second remote power supply 36 is coupled to the wrist band 30 and the second remote power supply 36 is electrically coupled to the second remote processor 32. The second remote power supply 36 comprises at least one battery.

A basketball court 38 is included and the game of basketball played thereon. The basketball court 38 has a perimeter 40 and a pair of basketball goals 42. Each of the basketball goals 42 includes a backboard 44 and a rim 46. The backboard 44 has a top edge 48 and the basketball court 38 may be a high school basketball court 38 or a college basketball court 38.

A base tracking array 50 is provided and the base tracking array 50 is positioned around the basketball court 38 and on each of the basketball goals 42. Each of the first 18 and second 28 remote tracking units is in electrical communication with the base tracking array 50. The base tracking array 50 tracks a location of the basketball 12 on the basketball court 38 during game play. The base tracking array 50 stores data received from the basketball 12 during game play. In this way the base tracking array 50 facilitates the data to be subsequently analyzed.

The base tracking array 50 comprises a plurality of court units 52 and each of the court units 52 is positioned on the basketball court 38. The court units 52 are spaced apart from each other and are distributed around the perimeter 40 of the basketball court 38. Each of the court units 52 comprises a court housing 54 that is positioned on the perimeter 40 of the basketball court 38.

A court processor 56 is positioned within the court housing 54 and a court transmitter 58 is positioned within the court housing 54. The court transmitter 58 is electrically coupled to the court processor 56 and the court transmitter 58 emits a court signal. The court transmitter 58 may be a radio frequency transmitter or the like. Additionally, the court transmitter 58 may employ a WPAN signal and Bluetooth communication protocols.

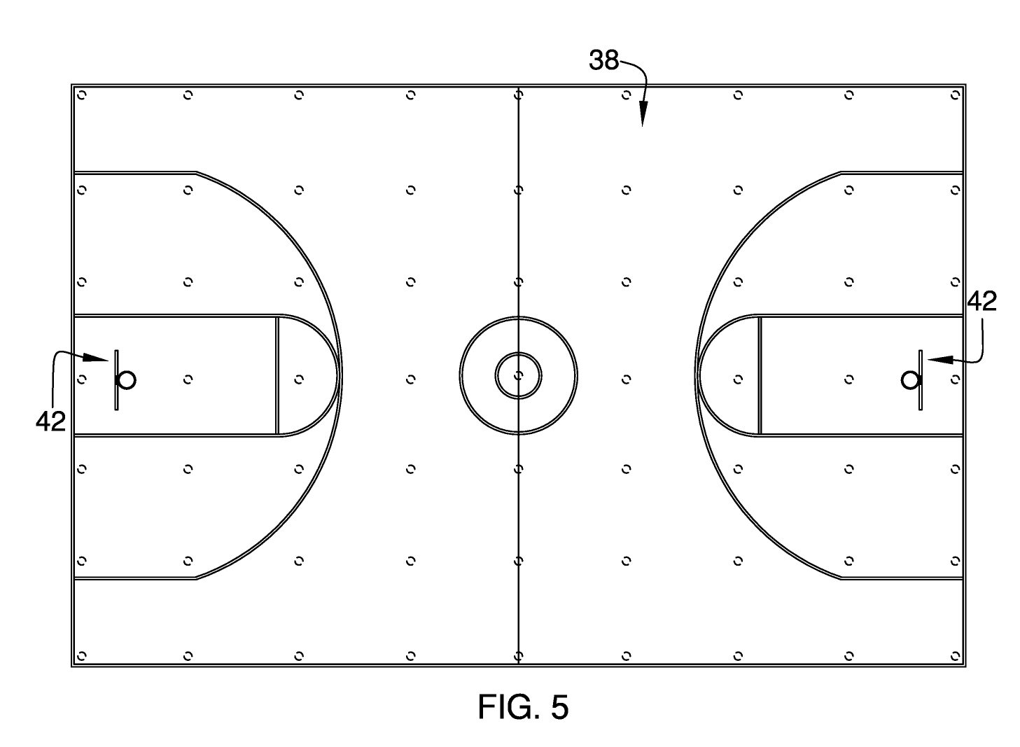

A court camera 60 is coupled to the court housing 54 to record images of the basketball court 38. The court camera 60 is electrically coupled to the court processor 56. Moreover, the court camera 60 may be a digital video camera or the like. A court power supply 62 is positioned within the court housing 54 and the court power supply 62 is electrically coupled to the court processor 56. The court power supply 62 comprises at least one battery. In an alternative embodiment 63 as shown in FIG. 5, the plurality of court units 52 may be embedded in the basketball court 38. The court units 52 may be spaced apart from each other and distributed over an entirety of the basketball court 38.

A plurality of goal units 64 is provided and each of the goal units 64 is coupled to an associated one of the basketball goals 42. Each of the goal units 64 comprises a goal housing 66 that is coupled to the top edge 48 of the backboard 44. A goal processor 68 is positioned within the goal housing 66 and the goal processor 68 may be an electronic processor.

A goal transmitter 70 is positioned within the goal housing 66 and the goal transmitter 70 is electrically coupled to the goal processor 68. The goal transmitter 70 emits a goal signal and the goal transmitter 70 may be a radio frequency transmitter or the like. Moreover, the goal transmitter 70 may employ a WPAN signal and Bluetooth communication protocols.

A goal camera 72 is coupled to the goal housing 66 to record images of the backboard 44 and the rim 46 corresponding to the associated basketball goal 42. The goal camera 72 is electrically coupled to the goal processor 68. Additionally, the goal camera 72 may be a digital video camera or the like. A goal power supply 74 is positioned within the goal housing 66 and the goal power supply 74 is electrically coupled to the goal processor 68. The goal power supply 74 comprises at least one battery.

A cradle 76 is provided that has a top surface 78 and a bottom surface 80. The top surface 78 is concavely arcuate to receive the basketball 12. A cradle processor 82 is positioned within the cradle 76 and the cradle processor 82 may be an electronic processor or the like. A receiver 84 is positioned within the cradle 76 and the receiver 84 is electrically coupled to the cradle processor 82. The receiver 84 is in electrical communication with each of the first remote transmitter 24, the second remote transmitter 34, the court transmitter 58 and the goal transmitter 70. The receiver 84 may be a radio frequency receiver 84 or the like. Moreover, the receiver 84 may employ a WPAN signal and Bluetooth communication protocols.

A signal analyzer 86 is provided and the signal analyzer 86 is positioned within the cradle 76. The signal analyzer 86 is electrically coupled to the cradle processor 82. Additionally, the signal analyzer 86 receives the first tracking signal, the second tracking signal, the goal signal and the court signal. The signal analyzer 86 may triangulate the first tracking signal with respect to the court signal corresponding to each of the court units 52 and the goal signal corresponding to each of the goal units 64. Additionally, the signal analyzer 86 may compare the signal strength of the first tracking signal with respect to the court signal corresponding to each of the court units 52 and the goal signal corresponding to each of the goal units 64. The signal analyzer 86 determines a real time position of the basketball 12 with respect to the basketball court 38 and each of the basketball goals 42 during game play. Additionally, the signal analyzer 86 determines a real time position of the player on the basketball court 38 during game play.

An output port 88 is coupled to the cradle 76 and the output port 88 is electrically coupled to the cradle processor 82. The output port 88 may be a usb port or the like. A cradle power supply 90 is positioned within the cradle 76 and the cradle power supply 90 is electrically coupled to the cradle processor 82. The cradle power supply 90 is in wireless communication with the first remote power supply 26 when the basketball 12 is positioned in the cradle 76. In this way the cradle power supply 90 charges the first remote power supply 26 when the basketball 12 is positioned on the cradle 76. The cradle power supply 90 may be a wireless battery charger or the like.

A data storage unit 92 is provided and the data storage unit 92 is selectively electrically coupled to the output port 88 on the cradle 76 via a usb cable or the like. The data storage unit 92 receives and stores the real time position of the basketball 12 and the player during game play, the images from the court camera 60 corresponding to each of the court units 52 and the images from the goal camera 72 corresponding to each of the goal units 64. The data storage unit 92 may be a personal computer or any other electronic device capable of storing electronic data. The data stored on the data storage unit 92 includes the real time location of the player and the basketball 12 during game play. Additionally, the data includes the images and video captured by each of the court cameras 60 and each of the goal cameras 72.

In use, the player wears the wrist band 30 and the player touches the basketball 12 while the basketball 12 is resting on the cradle 76. Information pertaining to the player is entered into the data storage unit 92 such as a name of the player and a jersey number of the player. The first remote sensors 22 detect when the basketball 12 is touched thereby triggering the first remote processor 20 to generate the link sequence. Each of the first remote transmitter 24, the second remote transmitter 34, the goal transmitter 70 corresponding to each of the goal units 64 and the court transmitter 58 corresponding to each of the court units 52 is synched with the receiver 84 when the first remote processor 20 generates the link sequence. Moreover, the signal analyzer 86 continuously determines the real time location of the player and the basketball 12 when the first remote processor 20 generates the link sequence. The basketball 12 is placed onto the cradle 76 when game play has ceased and the first remote processor 20 ceases generating the link sequence.

The data stored in the data storage unit 92 is downloaded to facilitate the data to be analyzed. The data is analyzed to determine performance statistics of the player to include, but not be limited to, shooting percentage, defensive statistics, assists and dribbling speed. Additionally, the video captured on each of the goal cameras 72 and each of the court cameras 60 is analyzed. In this way the player can identify weaknesses in the player's performance during game play to later improve on the weakness. Furthermore, a database of performance statistics over the lifetime of the player is compiled. In this way coaches, college recruiters and professional recruiters have comprehensive data with respect to the player's performance over the lifetime of the player.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A basketball tracking system comprising:
a basketball being configured to be manipulated during game play with respect to the game of basketball,
a first remote tracking unit being coupled to said basketball wherein said first remote tracking unit is configured to detect when said basketball is touched, said first remote tracking unit emitting a first tracking signal when said basketball is manipulated during game play;
a second remote tracking unit being configured to be worn during game play, said second remote tracking unit emitting a second tracking signal;
a basketball court being configured to have the game of basketball played thereon, said basketball court having a perimeter and a pair of basketball goals, each of said basketball goals including a backboard and a rim, said backboard having a top edge; and
a base tracking array being positioned around said basketball court and on each of said basketball goals, each of said first and second remote tracking units being in electrical communication with said base tracking array, said base tracking array tracking a location of said basketball on the basketball court during game play, said base tracking array storing data received from said basketball during game play wherein said base tracking array is configured to facilitate the date to be subsequently analyzed.

2. The system according to claim 1, wherein:
said basketball has an inner surface and an outer surface; and
said first remote tracking unit comprises a first remote processor being coupled to said inner surface, said first remote processor selectively generating a link sequence.

3. The system according to claim 2, further comprising a plurality of first remote sensors, each of said first remote sensors being coupled to said inner surface of said basketball, each of said first remote sensors being electrically coupled to said first remote processor, said first remote sensors being spaced apart from each other and being distributed around said basketball, each of said first remote sensors extending through said outer surface wherein each of said first remote sensors is configured to detect when said basketball is touched, said first remote processor generating said link sequence when said plurality of first remote sensors detects that said basketball has been touched.

4. The system according to claim 2, further comprising a first remote transmitter being coupled to said inner surface, said first remote transmitter being electrically coupled to said first remote processor, said first remote transmitter emitting said first tracking signal when said first remote processor generates said link sequence.

5. The system according to claim 2, further comprising a first remote power supply being coupled to said inner surface, said first remote power supply being electrically coupled to said first remote processor, said first remote power supply comprising at least one battery.

6. The system according to claim 1, wherein said second remote tracking unit comprises:
a wrist band being configured to be worn during game play; and
a second remote processor being coupled to said wrist band.

7. The system according to claim 6, further comprising:
a second remote transmitter being coupled to said wrist band, said second remote transmitter being electrically coupled to said second remote processor, said second remote transmitter emitting said second tracking signal; and
a second remote power supply being coupled to said wrist band, said second remote power supply being electrically coupled to said second remote processor.

8. The system according to claim 1, wherein said base tracking array comprises a plurality of court units, each of said court units being positioned on said basketball court, said court units being spaced apart from each other and being distributed around said perimeter of said basketball court.

9. The system according to claim 8, wherein each of said court units comprises:
a court housing being positioned on said perimeter of said basketball court;
a court processor being positioned within said court housing; and
a court transmitter being positioned within said court housing, said court transmitter being electrically coupled to said court processor, said court transmitter emitting a court signal.

10. The system according to claim 9, further comprising:
a court camera being coupled to said court housing, said court camera recording images of said basketball court, said court camera being electrically coupled to said court processor; and
a court power supply being positioned within said court housing, said court power supply being electrically coupled to said court processor.

11. The system according to claim 1, further comprising a plurality of goal units, each of said goal units being coupled to an associated one of said basketball goals.

12. The system according to claim 11, wherein each of said goal units comprises:
a goal housing being coupled to said top edge of said backboard;
a goal processor being positioned within said goal housing; and
a goal transmitter being positioned within said goal housing, said goal transmitter being electrically coupled to said goal processor, said goal transmitter emitting a goal signal.

13. The system according to claim 12, further comprising:
a goal camera being coupled to said goal housing, said goal camera recording images of said backboard and said rim corresponding to said associated basketball goal, said goal camera being electrically coupled to said goal processor, and
a goal power supply being positioned within said goal housing, said goal power supply being electrically coupled to said goal processor, said goal power supply comprising at least one battery.

14. The system according to claim 1, wherein:
said first remote tracking unit includes a first remote transmitter;
said second remote tracking unit includes a second remote transmitter; and
said base tracking array comprises:
a court transmitter emitting a court signal;
a goal transmitter emitting a goal signal;
a cradle having a top surface and a bottom surface, said top surface being concavely arcuate such that said top surface selectively receives said basketball;
a cradle processor being positioned within said cradle; and
a receiver being positioned within said cradle, said receiver being electrically coupled to said cradle processor, said receiver being in electrical communication with each of said first remote transmitter, said second remote transmitter, said court transmitter and said goal transmitter.

15. The system according to claim 14, further comprising a signal analyzer being positioned within said cradle, said signal analyzer being electrically coupled to said cradle processor, said signal analyzer receiving said first tracking signal, said second tracking signal, said goal signal and said court signal, said signal analyzer determining a real time position of said basketball with respect to said basketball court and each of said basketball goals during game play.

16. The system according to claim 15, further comprising:
an output port being coupled to said cradle, said output port being electrically coupled to said cradle processor, and
a court power supply being positioned within said cradle, said court power supply being electrically coupled to said cradle processor, said court power supply being in wireless communication with said first remote power supply, said court power supply charging said first remote power supply when said basketball is positioned on said cradle.

17. A basketball tracking system comprising:
a basketball being configured to be manipulated during game play with respect to the game of basketball, said basket ball having an inner surface and an outer surface;
a first remote tracking unit being coupled to said basketball wherein said first remote tracking unit is configured to detect when said basketball is touched, said first remote tracking unit emitting a first tracking signal when said basketball is manipulated during game play, said first remote tracking unit comprising:
a first remote processor being coupled to said inner surface, said first remote processor selectively generating a link sequence,
a plurality of first remote sensors, each of said first remote sensors being coupled to said inner surface of said basketball, each of said first remote sensors being electrically coupled to said first remote processor, said first remote sensors being spaced apart from each other and being distributed around said basketball, each of said first remote sensors extending through said outer surface wherein each of said first remote sensors is configured to detect when said basketball is touched, said first remote processor generating said link sequence when said plurality of sensors detects that said basketball has been touched,
a first remote transmitter being coupled to said inner surface, said first remote transmitter being electrically coupled to said first remote processor, said first remote transmitter emitting said first tracking signal when said first remote processor generates said link sequence, and
a first remote power supply being coupled to said inner surface, said first remote power supply being electrically coupled to said first remote processor, said first remote power supply comprising at least one battery;
a second remote tracking unit being configured to be worn during game play, said second remote tracking unit emitting a second tracking signal, said second remote tracking unit comprising:
a wrist band being configured to be worn during game play,
a second remote processor being coupled to said wrist band,
a second remote transmitter being coupled to said wrist band, said second remote transmitter being electrically coupled to said second remote processor, said second remote transmitter emitting said second tracking signal, and
a second remote power supply being coupled to said wrist band, said second remote power supply being electrically coupled to said second remote processor;
a basketball court being configured to have the game of basketball played thereon, said basketball court having a perimeter and a pair of basketball goals, each of said basketball goals including a backboard and a rim, said backboard having a top edge; and
a base tracking array being positioned around said basketball court and on each of said basketball goals, each of said first and second remote tracking units being in electrical communication with said base tracking array, said base tracking array tracking a location of said basketball on the basketball court during game play, said base tracking array storing data received from said basketball during game play wherein said base tracking array is configured to facilitate the date to be subsequently analyzed, said base tracking array comprising:
a plurality of court units, each of said court units being positioned on said basketball court, said court units being spaced apart from each other and being distributed around said perimeter of said basketball court, each of said court units comprising:
a court housing being positioned on said perimeter of said basketball court,
a court processor being positioned within said court housing,
a court transmitter being positioned within said court housing, said court transmitter being electrically coupled to said court processor, said court transmitter emitting a court signal,
a court camera being coupled to said court housing, said court camera recording images of said basketball court, said court camera being electrically coupled to said court processor, and
a court power supply being positioned within said court housing, said court power supply being electrically coupled to said court processor;
a plurality of goal units, each of said goal units being coupled to an associated one of said basketball goals, each of said goal units comprising:
a goal housing being coupled to said top edge of said backboard,
a goal processor being positioned within said goal housing,
a goal transmitter being positioned within said goal housing, said goal transmitter being electrically coupled to said goal processor, said goal transmitter emitting a goal signal,
a goal camera being coupled to said goal housing, said goal camera recording images of said backboard and said rim corresponding to said associated basketball goal, said goal camera being electrically coupled to said goal processor, and
a goal power supply being positioned within said goal housing, said goal power supply being electrically coupled to said goal processor, said goal power supply comprising at least one battery;
a cradle having a top surface and a bottom surface, said top surface being concavely arcuate such that said top surface selectively receives said basketball,
a cradle processor being positioned within said cradle,
a receiver being positioned within said cradle, said receiver being electrically coupled to said cradle processor, said receiver being in electrical communication with each of said first remote transmitter, said second remote transmitter, said court transmitter and said goal transmitter,
a signal analyzer being positioned within said cradle, said signal analyzer being electrically coupled to said cradle processor, said signal analyzer receiving said first tracking signal, said second tracking signal, said goal signal and said court signal, said signal analyzer determining a real time position of said basketball with respect to said basketball court and each of said basketball goals during game play,
an output port being coupled to said cradle, said output port being electrically coupled to said cradle processor, and
a cradle power supply being positioned within said cradle, said cradle power supply being electrically coupled to said cradle processor, said cradle power supply being in wireless communication with said first remote power supply, said cradle power supply charging said first remote power supply when said basketball is positioned on said cradle; and
a data storage unit being selectively electrically coupled to said output port on said cradle, said data storage unit receiving and storing said real time position of said basketball during game play, said images from said court camera corresponding to each of said court units and said images from said goal camera corresponding to each of said goal units.
